(19) United States
(12) Patent Application Publication
(10) Pub. No.: US 2025/0083946 A1
(43) Pub. Date: Mar. 13, 2025

(54) HYDROSTATIC LOADING SYSTEM

(71) Applicant: Accuracy Painting LLC, Oxford, MI (US)

(72) Inventor: Mitchell A. Kohler, Oxford, MI (US)

(21) Appl. No.: 18/464,242

(22) Filed: Sep. 10, 2023

(51) Int. Cl. B67D 7/78; B44D 3/00; B67D 7/02

(52) U.S. Cl. CPC B67D 7/78; B44D 3/00; B67D 7/02

(57) ABSTRACT

A hydrostatic loading system may comprise a dispensing assembly, a hose assembly, a cradle assembly, and a positioning assembly. The dispensing assembly may include a dispensing head, a sealing rim, and a container. The dispensing head may include an equalization port and a supply port. The hose assembly may be configured to connect to the dispensing head. The cradle assembly may be configured to engage the dispensing assembly. The positioning assembly may be configured to move the cradle assembly between a loading configuration and a dispensing configuration. The dispensing head may be configured to transfer air via the equalization port and transfer fluid via the supply port.

### BACKGROUND

Traditional paint loading techniques require a painter to buy paint in specific quantities distributed in generalized volumes to satisfy both the masses and specific demands of each project, e.g., one quart, one gallon, five gallon, etc. Larger jobs need to be completed using a sprayer for optimum efficiency. A significant issue with spraying any larger project is that it needs one or more additional workers for reloading to maximize efficiency while minimizing waste.

Traditional approaches have considerable shortcomings. Either using multiple feeding hoses with corresponding buckets or increasing the bucket size results in unnecessary exposure to environmental elements, contamination, unwanted paint drying and buildup, and excessive use of typical containers.

There is a need for the systems and methods herein that provide solutions to traditional techniques. The systems herein utilize hydrostatic pressure for paint loading to keep a reservoir filled to a specified level, without stopping work for refilling. The systems herein allow a painter to feed any volume of paint into a bucket container (e.g., one gallon), without requiring interruptions for reloading. This minimizes waste by keeping unused paint stored in a sealed bucket container until needed, thereby keeping material free from contaminants and premature drying. In addition, the systems herein eliminate the need for extraneous workers while maintaining an efficient pace. The systems herein provide various advantages including balancing efficiency throughout material application, waste management, and fiduciary requirements.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent illustrations of various embodiments, the drawings are not necessarily to scale, and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 illustrates a perspective view of an exemplary dispensing system of the present disclosure;

FIG. 2 illustrates a perspective view of an exemplary dispensing assembly of the present disclosure;

FIG. 3 illustrates a closer top view of an exemplary dispensing head of the present disclosure;

FIG. 4 illustrates a closer bottom view of an exemplary dispensing head of the present disclosure;

FIG. 5 illustrates a side view of an exemplary hose assembly of the present disclosure;

FIG. 6 illustrates a perspective view of an exemplary positioning assembly of the present disclosure, e.g., in a dispensing condition;

FIG. 7 illustrates a perspective of an exemplary positioning assembly of the present disclosure, e.g., in a loading condition; and

FIG. 8 illustrates a rear view of an exemplary latching assembly of the present disclosure.

### DETAILED DESCRIPTION

A hydrostatic loading system may comprise a dispensing assembly, a hose assembly, a container assembly, a cradle assembly, and a positioning assembly. The container assembly may include a container, a container lid, and a ring seal. The dispensing assembly may include a dispensing head and a sealing rim. The dispensing head may include an equalization port and a supply port. The hose assembly may be configured to connect to the dispensing head.

The dispensing assembly may include a handle, a valve (e.g., ball valve shutoff), a pivot, a spout (e.g., telescoping), and a hose assembly connection (e.g., threaded). The handle may include a position-locking clip to hold the dispensing handle in place while in the dispensing condition. The pivot may be configured to rotate and reduce tension on the dispenser handle. The spout may be configured to control supply and intake lines simultaneously to regulate liquid flow.

The hose assembly may include one or a plurality of hoses, a dispenser connection (e.g., threaded), and a lid connection (e.g., threaded). The hoses may include an intake line and a supply line, e.g., held together with a braided sleeve. The dispenser and lid connections may have a common imprint and include a male end and a female end, thereby keeping intake and supply separate and allowing for attachment of additional hoses.

The container assembly may include a container (e.g., five-gallon bucket container), a container lid, a lid sealing ring, a transverse line (e.g., intake line as part of the lid), a valve (e.g., 90-degree ball valve), a longitudinal stem (e.g., telescoping intake stem), a hose assembly connection (e.g., threaded), and a supply port. The lid may include a tapered surface for drainage. The telescoping intake stem may extend between the valve and the bottom of the container. The supply port may be included in the hose connection on lid.

The positioning assembly may include a cradle assembly and a stand. The stand may include a locking pivot to selectively move the cradle assembly between a loading condition and a dispensing condition. The cradle assembly may be configured to engage the dispensing assembly and may include a lid depressing locking mechanism to apply a force to assist in sealing the lid against the container. The positioning assembly may be configured to move the cradle assembly between a loading configuration and a dispensing configuration. The dispensing head may be configured to transfer air via the equalization port and transfer fluid via the supply port.

The dispensing assembly may include a proximal elbow, a transverse line (e.g., tubular intake line), a distal elbow (e.g., ball valve), and a longitudinal stem (e.g., telescoping tubular stem). The proximal elbow may extend from the dispensing head at a top proximal portion of the container. The transverse line may extend from the proximal elbow to a top distal portion of the container. The distal elbow may connect the transverse line and the longitudinal stem at the top distal portion. The longitudinal stem may extend from the distal elbow to a bottom distal portion of the container.

The container may include a container lid and a container seal. The cradle assembly may include a latching assembly configured to wrap around the container lid and the container. The latching assembly may be configured to compress the container seal between the container lid and the container.

The hose assembly may include a dispenser handle assembly, a dispenser pivot, and a dispenser arm. The dispenser pivot allows rotation of the dispenser arm between a bent configuration and a straight configuration. The dispenser arm includes an air supply line configured to control air flow and selectively telescope for regulation of a liquid flow rate. The dispenser arm includes a liquid supply line configured to control liquid flow and selectively telescope relative to a depth within a reservoir, e.g., for paint.

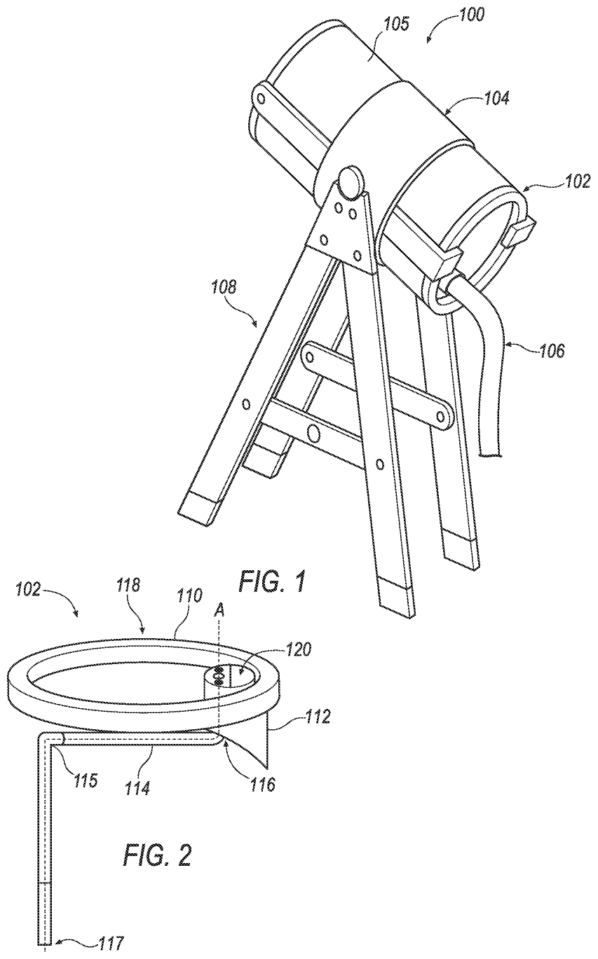

FIG. 1 illustrates an exemplary system 100 of the present disclosure, e.g., a dispensing system. System 100 may include dispensing assembly 102, cradle assembly 104, hose assembly 106, and positioning assembly 108. System 100 and/or dispensing assembly 102 may include container 105, e.g., for new, unused and/or undispensed liquid such as paint. Container 105 may include a container lid and an upper seal (e.g., ring seal). The container lid may compress the seal between the cover lid and container 105 to create a fluid-tight seal.

FIGS. 2-4 illustrate an exemplary dispensing assembly 102 of the present disclosure. As shown in FIG. 2, dispensing assembly 102 may include sealing rim 110, liquid shield 112, transverse line 114 (e.g., tubular intake line), distal elbow 115 (e.g., hinged ball valve), proximal elbow 116 (e.g., hinged ball valve), longitudinal stem 117 (e.g., telescoping tubular stem), cover plate 118, and dispensing head 120. Distal and proximal elbows 115, 116 may each include a valve (e.g., hinged ball valve) to facilitate collapse toward cover plate 118 for storage and extension into container 105 for dispensing. Shield 112 may be configured to protect proximal elbow 116 and serve as a lip to direct flow of liquid between container 105 and dispensing head 120. Dispensing head 120 may include external threads to connect with and seal relative to hose assembly 106.

System 100 may be configured to exchange air and liquid (e.g., paint) via respective passages of dispensing head 120. System 100 may pass air through dispensing head 120, proximal elbow 116, transverse line 114, distal tubular line 115, and longitudinal stem 117, e.g., to maintain air flow and balance air pressure between hose assembly 106 and container 105. System 100 may pass liquid from container 105, through dispensing head 120, and to hose assembly 106, e.g., to maintain liquid flow and balance hydrostatic pressure between hose assembly 106 and container 105.

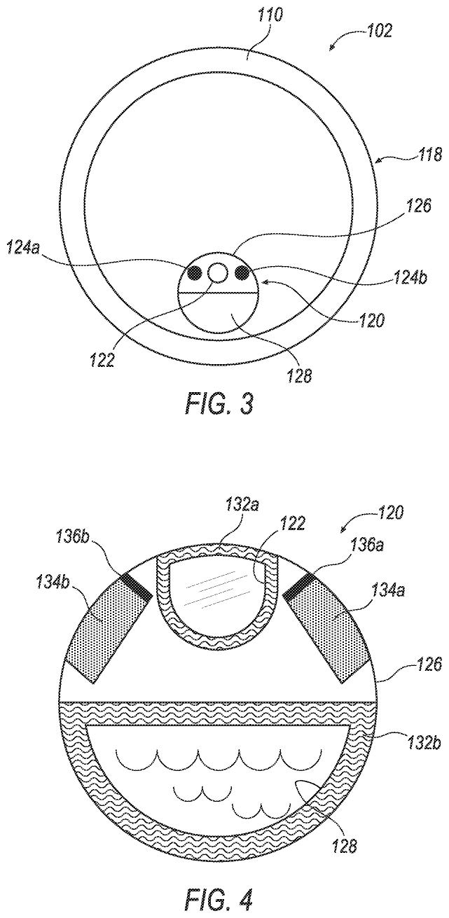

As shown in FIG. 3, dispensing head 120 may include equalization port 122 (e.g., for air flow), alignment pins 124a, 124b, and supply port 128 (e.g., for liquid flow). As shown in FIG. 4, dispensing head 120 may include seals 132a, 132b, hose guides 134a, 134b, and hose clips 136a, 136b. Pins 124a, 124b may be configured as alignment guides configured to be received in corresponding recesses or channels of hose assembly 106.

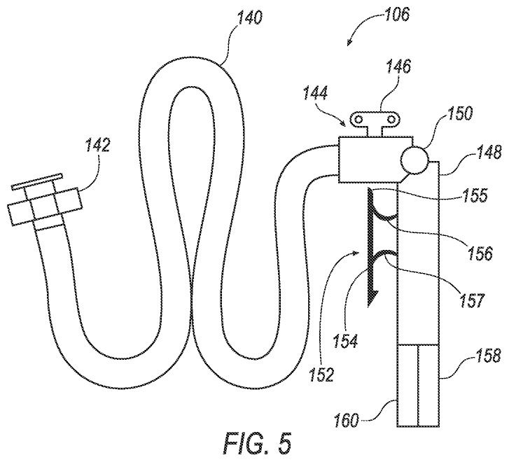

FIG. 5 illustrates an exemplary hose assembly 106 of the present disclosure. Hose assembly 106 may include hose tubing 140, hose connector 142, and dispenser handle assembly 144. Dispenser handle assembly 144 may include valve handle 146, dispenser arm 148 (e.g., telescoping), dispenser pivot 150 (e.g., selectively locking), and dispenser clip 152 (e.g., for container engagement).

Clip 152 may be configured to secure dispenser handle assembly 144 to container 105. Clip 152 may include distal hook 154, proximal hook 155, and transverse supports 156, 157. Clip 152 may be configured to engage and interdigitate with circumferential protrusions around an upper, exterior portion of container 105.

Dispenser arm 148 may include supply line 158 (e.g., for inflow and/or outflow of air) and supply line 160 (e.g., for inflow and/or outflow of liquid such as paint). Supply line 158 may be configured to control air flow and selectively telescope for regulation of a liquid flow rate. Supply line 160 may be configured to control liquid flow and selectively telescope relative to a desired depth within container 105, e.g., an internal bottom surface of container 105. Supply line 160 may be configured to be positioned above the liquid level (e.g., paint level) in container 105, e.g., to optimize liquid flow in the dispensing configuration.

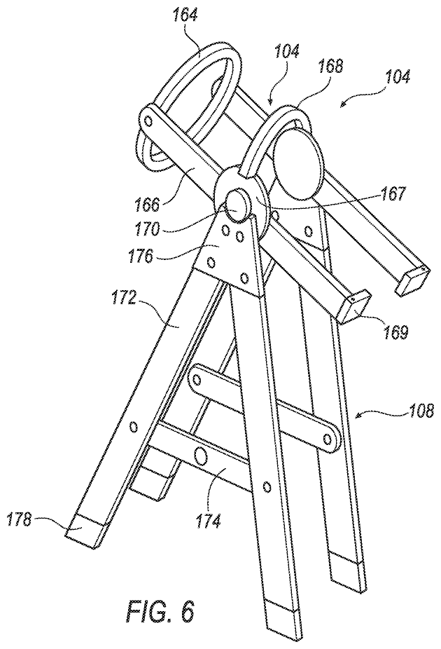

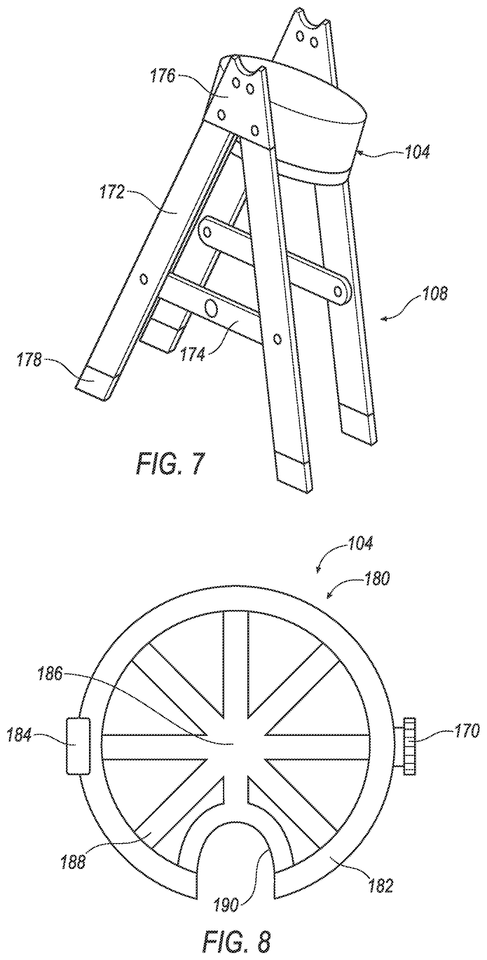

FIGS. 6-7 illustrate an exemplary positioning assembly 108 of the present disclosure, e.g., in dispensing and loading conditions, respectively. Positioning assembly 108 may be configured as a stand. Positioning assembly 108 may include distal seating ring 164, longitudinal support arms 166, locking swivel plates 167, proximal seating ring 168, proximal end latches 169, pivot hinges 170, vertical support legs 172, transverse collapsible brace 174, top brace 176, and feet 178. Feet 178 may include traction pads (e.g., for fixed ground contact), a dolly mechanism with wheels (e.g., for rolling ground contact), or a combination thereof. Positioning assembly 108 may be configured to move system 100 between a dispensing condition (e.g., FIGS. 1 and 6) and a loading condition (e.g., FIG. 7). Latches 169 may be configured to hold, clamp, and minimize spilling of container 105 in the dispensing and loading conditions.

FIG. 8 illustrates an exemplary cradle assembly 104 including latching assembly 180. Latching assembly 180 may include ring 182, latch 184 (e.g., compression-hinge), spindle 186, and hose passage 190. Latching assembly 180 may be configured to wrap around the container lid and container 105, thereby securing and compressing the container seal between the container lid and container 105.

It will be appreciated that the method and devices herein may be modified to have some components and steps removed, or may have additional components and steps added, all of which are deemed to be within the spirit of the present disclosure. None of the components or steps herein are essential elements nor is their interdependency required. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

What is claimed is:

1. A hydrostatic loading system comprising:
a dispensing assembly including a dispensing head, a sealing rim, and a container, the dispensing head including an equalization port and a supply port;
a hose assembly configured to connect to the dispensing head;
a cradle assembly configured to engage the dispensing assembly; and
a positioning assembly configured to move the cradle assembly between a loading configuration and a dispensing configuration,
wherein the dispensing head is configured to transfer air via the equalization port and transfer fluid via the supply port.

2. The system of claim 1, further comprising a proximal elbow, a transverse line, a distal elbow, and a longitudinal stem, the proximal elbow extending from the dispensing head at a top proximal portion of the container, the transverse line extending from the proximal elbow to a top distal portion of the container, the distal elbow connecting the transverse line and the longitudinal stem at the top distal portion, and the longitudinal stem extending from the distal elbow to a bottom distal portion of the container.

3. The system of claim 1, wherein the container includes a container lid and a container seal, and the cradle assembly includes a latching assembly configured to wrap around the container lid and the container.

4. The system of claim 3, wherein the latching assembly is configured to compress the container seal between the container lid and the container.

5. The system of claim 1, wherein the hose assembly includes a dispenser handle assembly, a dispenser pivot, and a dispenser arm, wherein the dispenser pivot allows rotation of the dispenser arm between a bent configuration and a straight configuration.

6. The system of claim 5, wherein the dispenser arm includes an air supply line configured to control air flow and selectively telescope for regulation of a liquid flow rate.

7. The system of claim 5, wherein the dispenser arm includes a liquid supply line configured to control liquid flow and selectively telescope relative to a depth within the container.

8. A hydrostatic dispensing assembly comprising:
a dispensing head including an equalization port and a supply port;
a sealing rim;
a cover plate;
a transverse line connected to the dispensing head; and
a longitudinal stem connected to the transverse line,
wherein the dispensing head is configured to transfer air between the equalization port and a distal portion of the longitudinal stem, and the dispensing head is configured to transfer liquid between the supply port and the distal portion of the longitudinal stem.

9. The assembly of claim 8, further comprising:
a container,
a hose assembly configured to connect to the dispensing head;
a cradle assembly configured to engage the dispensing assembly; and
a positioning assembly configured to move the cradle assembly between a loading configuration and a dispensing configuration.

10. The assembly of claim 9, further comprising a proximal elbow and a distal elbow, the proximal elbow extending from the dispensing head at a top proximal portion of the container, the transverse line extending from the proximal elbow to a top distal portion of the container, the distal elbow connecting the transverse line and the longitudinal stem at the top distal portion, and the longitudinal stem extending from the distal elbow to a bottom distal portion of the container.

11. The assembly of claim 9, wherein the container includes a container lid and a container seal, and the cradle assembly includes a latching assembly configured to wrap around the container lid and the container.

12. The assembly of claim 11, wherein the latching assembly is configured to compress the container seal between the container lid and the container.

13. The assembly of claim 9, wherein the hose assembly includes a dispenser handle assembly, a dispenser pivot, and a dispenser arm, wherein the dispenser pivot allows rotation of the dispenser arm between a bent configuration and a straight configuration.

14. The assembly of claim 13, wherein the dispenser arm includes an air supply line configured to control air flow and selectively telescope for regulation of a liquid flow rate.

15. The assembly of claim 13, wherein the dispenser arm includes a liquid supply line configured to control liquid flow and selectively telescope relative to a depth within the container.

16. A method of a hydrostatic dispensing system, the method comprising:
providing a dispensing head including an equalization port and a supply port;
providing a sealing rim and a cover plate;
providing a transverse line connected to the dispensing head; and
providing a longitudinal stem connected to the transverse line, wherein the dispensing head is configured to transfer air between the equalization port and a distal portion of the longitudinal stem, and the dispensing head is configured to transfer liquid between the supply port and the distal portion of the longitudinal stem.

17. The method of claim 16, further comprising:
providing a container;
providing a hose assembly configured to connect to the dispensing head;
providing a cradle assembly configured to engage the dispensing assembly; and
providing a positioning assembly configured to move the cradle assembly between a loading configuration and a dispensing configuration.

18. The method of claim 17, further comprising providing a proximal elbow and a distal elbow, the proximal elbow extending from the dispensing head at a top proximal portion of the container, the transverse line extending from the proximal elbow to a top distal portion of the container, the distal elbow connecting the transverse line and the longitudinal stem at the top distal portion, and the longitudinal stem extending from the distal elbow to a bottom distal portion of the container.

19. The method of claim 17, wherein the container includes a container lid and a container seal, and the cradle assembly includes a latching assembly configured to wrap around the container lid and the container.

20. The method of claim 19, wherein the latching assembly is configured to compress the container seal between the container lid and the container.
